(19) United States
(12) Patent Application Publication
(10) Pub. No.: US 2022/0080807 A1
(43) Pub. Date: Mar. 17, 2022

(54) ELECTRIC RADIATOR FOR A MOTOR VEHICLE PROVIDED WITH A TEMPERATURE MEASUREMENT DEVICE

(71) Applicant: Valeo Systemes Thermiques, Le Mesnil Saint-Denis (FR)

(72) Inventors: Romain Delcourt, Le Mesnil Saint-Denis (FR); Pascal Fourgous, Le Mesnil Saint-Denis (FR); Jonathan Fournier, Le Mesnil Saint-Denis (FR); Théo Deletang, Le Mesnil Saint-Denis (FR)

(73) Assignee: Valeo Systemes Thermiques, Le Mesnil Saint-Denis (FR)

(21) Appl. No.: 17/456,760

(22) Filed: Nov. 29, 2021

Related U.S. Application Data
(63) Continuation of application No. PCT/EP2020/063105, filed on May 11, 2020.

(30) Foreign Application Priority Data
May 27, 2019 (FR) 1905574

(51) Int. Cl. B60H 1/00; B60H 1/22; F24H 3/04; F24H 9/20

(52) U.S. Cl. CPC B60H 1/00792; B60H 1/2225; F24D 2220/042; F24H 9/2071; B60H 2001/2256; F24H 3/0435

(57) ABSTRACT

The invention relates to an electric radiator (1) for a motor vehicle comprising a rigid frame housing heating elements (18) and radiating elements (12) through which an air flow can pass, the radiator being provided with a temperature measurement device (2) comprising at least one temperature sensor (4) and a support element (5) comprising at least one housing (51) for one or more temperature sensors (4) and an electric radiator attachment device, characterised in that the attachment device associated with the support element (5) comprises at least one snap-fastening element (6) configured to cooperate with one of the radiating elements (12) of the radiator (1).

The present invention pertains to the field of the ventilation, heating and/or air conditioning of motor vehicles and relates more particularly to a temperature measurement device for an electric radiator of a ventilation, heating and/or air conditioning system of a vehicle.

It is known practice to use electric radiators in a ventilation, heating and/or air conditioning system of a vehicle. An electric radiator can for example be positioned across the path of an air stream, in order to heat said air stream. Such a radiator includes a frame in which heating elements are accommodated, these heating elements being configured to be in contact with the air passing through so as to promote an exchange of heat energy between the air and the heating elements.

These heating elements can in particular include PTC, or positive temperature coefficient, stone or ceramic. The supply of power to these resistive elements generates the heating of the heating element. The exchange of heat energy can be improved by the presence of radiating elements associated with the heating elements so as to increase the exchange surface area with the air passing through this electric radiator.

In order to control the heating emanating from such a radiator, it is known practice to arrange temperature sensors in the path of the air stream leaving the radiator. These temperature sensors are positioned on a support, for example a face of the frame situated in line with the face of the radiator through which the air stream leaves the radiator and comprising recesses receiving the sensors. The temperature sensors can also be accommodated inside a grille covering said face of the frame.

Such positioning of the temperature sensors causes several problems. Whatever type of support the temperature sensors are placed on, it must be suitable for the dimensions of the radiator facing which it is positioned. It is also possible that the fastening means provided for fastening a support to a given radiator must be modified as the use of this support with a different frame of another radiator requires suitable fastening means. Whether for questions of sizing or fastening in particular, it is thus common to provide a specific design of a support in relation to a radiator, the support being suitable for a single type of radiator with particular dimensions and shapes.

The present invention makes it possible to solve the problem by proposing a temperature measurement device that can be fitted in a more versatile manner to various types of electric radiator.

The invention relates to an electric radiator for a motor vehicle, positioned in particular in a heating, ventilation and air conditioning installation, comprising a rigid frame accommodating heating elements and radiating elements through which an air stream can pass, said radiator being provided with a temperature measurement device including at least one temperature sensor and a support element comprising at least one recess for one or more temperature sensors and a device for fastening to the electric radiator, characterized in that the fastening device associated with the support element includes at least one snap-fit fastening member configured to interact with one of the radiating elements of the radiator.

The radiator is made up of a heating body positioned in the frame and made up of radiating elements and heating elements alternating in a transverse direction and respectively extending longitudinally. Each heating element includes resistive elements the supply of electricity to which generates heating, said resistive elements being accommodated in a tube or embedded in a material forming an electrical insulator. Each radiating element consists of a corrugated sheet each peak of which is adhesively bonded or brazed to a heating element or a rigid portion of the frame.

The temperature measurement device having been fastened as stated facing the radiator, the temperature sensor is then capable of measuring the temperature of the air stream leaving the radiator, the support element ensuring that at least one temperature sensor is held at the output of the air stream from the radiator.

According to the invention, placing the temperature sensor in the air stream leaving the radiator means that it does not need to be inserted into a grille extending over an entire face of the radiator and fastened to the perimeter of the rigid frame of the radiator. The mechanical footprint is therefore limited. In addition, fastening the temperature sensor on with the radiating elements makes it possible to be freed from the constraints of variable dimensions and shapes of the rigid frame from one radiator to another, so that a single format of temperature measurement device according to the invention can be placed on different radiator models.

According to one feature of the invention, the support element is made from a heat-resistant material, for example a polymer, in order to withstand the high temperatures of the air stream leaving the radiator.

As stated, the snap-fit fastening member is configured so that it can be inserted directly into the radiator, between one of the radiating elements thereof. More particularly, the snap-fit fastening member includes hook means sized so that they can be accommodated between fins of one of the radiating elements arranged to allow an air stream to pass through the radiator.

According to one feature of the invention, each snap-fit fastening member is configured to allow the removable fastening of the temperature measurement device to one of the radiating elements. The temperature measurement device can thus be fitted or removed at will.

According to one feature of the invention, the snap-fit fastening member is sized to deform the radiating elements when the temperature sensor is assembled on the radiator in a first translation direction and the corresponding radiating elements are formed between two rigid elements, for example two heating elements, or a heating element and part of the rigid structure of the frame, so as to generate an elastic return effect that tends to prevent the disengagement of the fastening member in a second translation direction opposite to the first direction.

As stated, the radiating elements each consist of a corrugated sheet, so that the insertion of a rigid element through the corrugations of the sheet tends to plastically deform the sheet. However, the transverse dimension of the fastening member relative to the transverse dimension of the corrugated sheet forming the radiating element, combined with the fact that the corrugated sheet is clamped between two heating elements, or between a heating element and a rigid element of the frame, provides a slight elastic return effect that tends to lock the fastening member in position, and it can only be released through a specific pulling force exerted by a user.

According to one feature of the invention, the snap-fit fastening member comprises at least one tab extending from the body of the support element and a ramp protruding from said tab. The body of the support element is thus extended by at least one snap-fit fastening member, and the number of these snap-fit fastening members on the support can depend for example on the size of the support. The greater the number of snap-fit fastening members, the greater the mechanical hold. The snap-fit fastening member, and more particularly the tab thereof, originates from the body of the support element and extends it along an axis perpendicular to the axis of elongation of the support element. The tab is configured to be inserted into one of the radiating elements accommodated in the frame of the radiator.

The snap-fit fastening member comprises at least one ramp protruding relative to the tab. A ramp is in particular provided at the free end of the tab, that is, at the opposite end from the support element. The ramp has an oblique wall facilitating the insertion of the fastening member into the radiating elements of the radiator. A stop face, perpendicular to the main plane of extension of the tab and positioned in the opposite direction to the oblique wall, makes it possible to form a stop against said radiating elements counter to the disengagement of the snap-fit fastening member and to hold the fastening member inside the radiating elements of the radiator. The position of the temperature measurement device is then mechanically secured by means of the stop face of the ramp of the fastening member. The tab of the fastening member can form the base of a plurality of ramps providing improved hooking of the radiating elements of the radiator. The stop face of the ramp can for example hook into a louver of the radiating elements of the radiator if they comprise louvers.

According to one feature of the invention, the support element has an elongated shape in a longitudinal direction along which several recesses are positioned in series and the snap-fit fastening members are aligned in the same longitudinal direction so that each snap-fit fastening member interacts with a radiating element specific thereto.

The temperature measurement device can thus accommodate a plurality of temperature sensors, which can be aligned with each other in a main direction parallel to the direction of elongation of the support element and in particular in a direction parallel to the direction of the stacking of the radiating and heating elements on one another in the heating body of the radiator. The temperature sensors can thus be aligned in a direction ensuring the measurement of the temperature of the heating in several separate zones of the heating body corresponding to several radiating elements. It is obvious that in this embodiment, the temperature sensors are separated from the neighboring sensors by a sufficient distance so that each of said temperature sensors takes meaningful measurements in relation to each other. The temperature measurement device is positioned on a face of the radiator, advantageously the output face of the radiator that emanates the air stream the temperature of which is increased by the heating of the heating elements of the radiator.

The recess making it possible to receive a temperature sensor is configured to improve the reliability of the temperature measurement taken by the temperature sensor, while ensuring the protection thereof.

Alternatively, the support element can be associated with a single temperature sensor and have a compact shape defining a single recess, and the snap-fit fastening members are facing on either side of the recess so that the snap-fit fastening members interact with the same radiating element.

According to one feature of the invention, the temperature sensor can be an NTC sensor, chosen in particular for its sensitivity to temperature variations.

According to one feature of the invention, the temperature sensor is configured to be connected to a connection interface of the radiator by electrical wires. The electrical connection between the radiator and the temperature sensor makes it possible to power the temperature sensor. Another function of the electrical wires can also be the transmission of information from the temperature sensor to the radiator, and more specifically to its connection interface. The temperature sensor can for example be configured to send a signal to the connection interface of the radiator when a temperature threshold read by the temperature sensor is reached by the air stream emanating from the radiator. The parameters of the radiator can then be modified as a function of the temperature read by the temperature sensor.

According to one feature of the invention, the support element can comprise at least one channel accommodating the electrical wires. The channel is for example molded into the material of the support element in order to act as a zone for receiving the electrical wires linked to the temperature sensor. The channel thus acts as a thermal barrier so that the air stream leaving the radiator does not damage the electrical wires.

The support element can also comprise a cover capable of interacting with the channel. The interaction between the channel and the cover forms an inner space suitable for receiving the electrical wires. In such an embodiment, the interaction between the channel and the cover ensures that the electrical wires are mechanically held inside the support element as well as performing the thermal barrier function.

According to one feature of the invention, the support element is in the shape of a cap the inside of which defines the recess, the cap enclosing a single temperature sensor and being pierced with orifices capable of letting the air through to the temperature sensor. This embodiment ensures that the support element fully encloses and protects the temperature sensor. The cap is pierced with orifices so that the temperature sensor can retain direct contact with the air stream emanating from the radiator and thus measure the temperature thereof.

According to one embodiment of the invention, the fastening clip of the temperature measurement device is inserted between fins of one of the radiating elements of the radiator through a front face thereof, the tab of the fastening clip having a main dimension that is larger than a corresponding dimension, here the thickness, of the radiating elements of the radiator and extending so that a stop wall of the ramp stops on a rear air face of the radiator. Such an embodiment promotes the hooking of the ramp onto the radiator. The stop face of the ramp, rather than hooking onto the louvers of the radiating elements of the radiator, can extend beyond the radiating elements if the length of the tab allows, until it passes through the radiating elements and emerges on a rear air face of the radiator, that is, the opposite face from a front face of the radiator, which corresponds to the face of the radiator into which the temperature measurement device is inserted, or the face of the radiator from which the air stream emerges from the radiator. The stop face of the ramp will thus stop on the end of the radiating elements situated on the side of the rear face of the radiator. This embodiment thus provides an alternative hooking of the fastening clip onto the structure of the radiator, for example if said radiator does not comprise any louvers on its radiating elements.

According to one feature of the invention, the temperature sensor is situated at a distance of at least 10 mm from the air output face of the radiator.

Advantageously, the temperature sensor must be situated sufficiently far away from the output face of the radiator from which the air stream emanates. If the temperature sensor is too close to one of the heating elements of the radiator, said temperature sensor will measure a false temperature as it will be too concentrated on a particular zone of the radiator. The temperature sensor can also not be too far away from the output face in order to avoid an excessive footprint of the radiator provided with the temperature measurement device.

Further details, features and advantages will become more clearly apparent from reading the detailed description given below by way of illustration and with reference to the associated figures, in which:

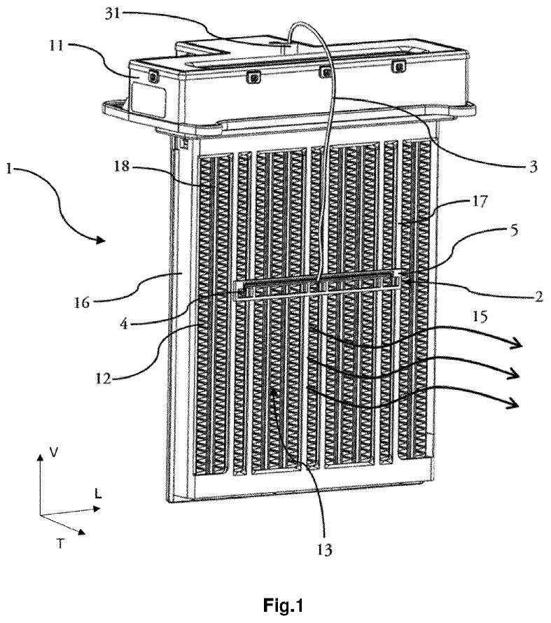

FIG. 1 is a general representation of a first embodiment of a temperature measurement device positioned on a radiator,

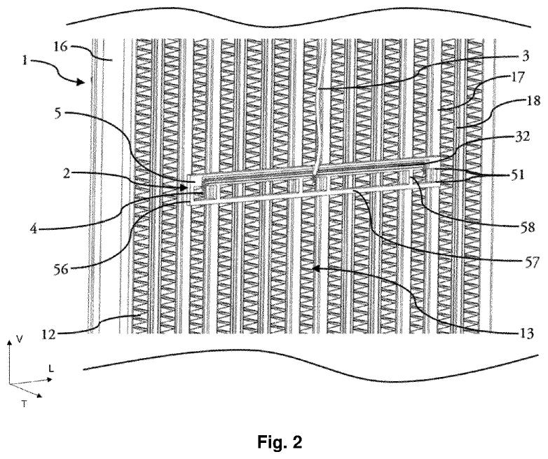

FIG. 2 is a more detailed view of the temperature measurement device,

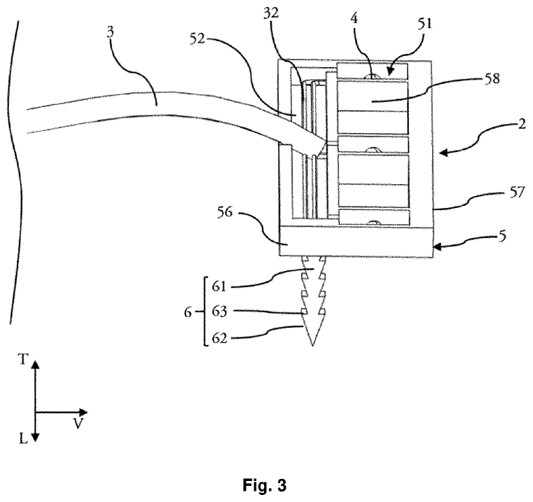

FIG. 3 is a view of the temperature measurement device illustrating a first embodiment of a snap-fit fastening member provided on said device,

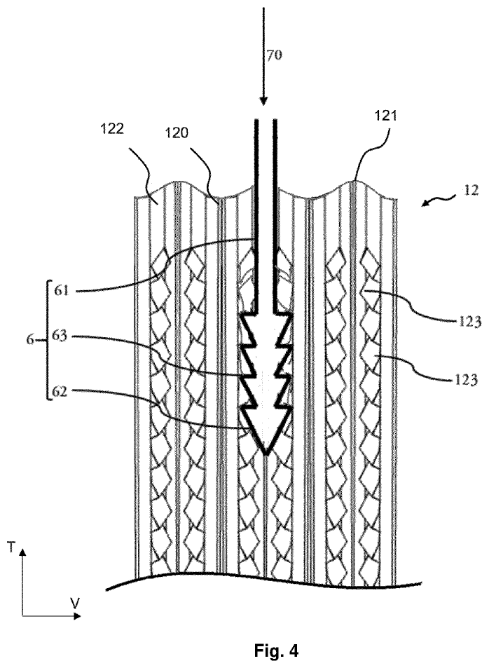

FIG. 4 is a schematic representation of the snap-fit fastening member according to the first embodiment inserted into a radiating element of the radiator,

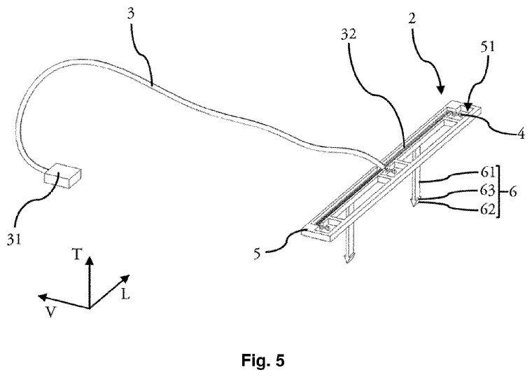

FIG. 5 is a view of the temperature measurement device illustrating a second embodiment of a snap-fit fastening member provided on said device,

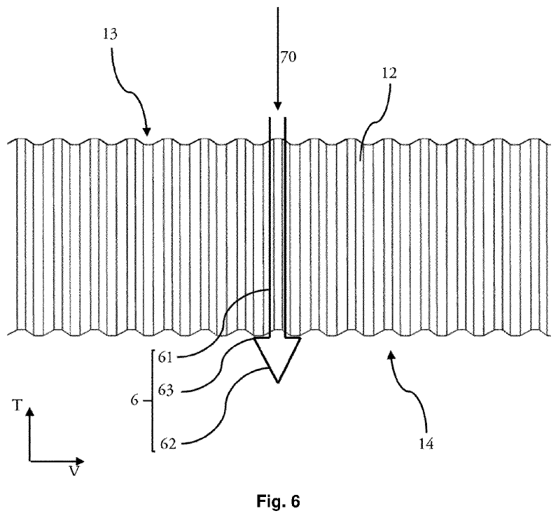

FIG. 6 is a schematic representation of the snap-fit fastening member according to the second embodiment inserted into a radiating element of the radiator,

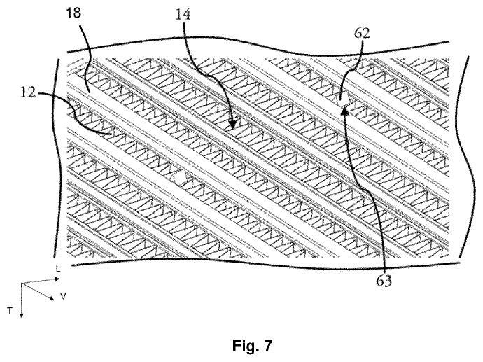

FIG. 7 is a front view of a face of the radiator on the opposite side from the face opposite which the temperature measurement device is positioned, from which a free end of snap-fit fastening members according to the second embodiment emerges,

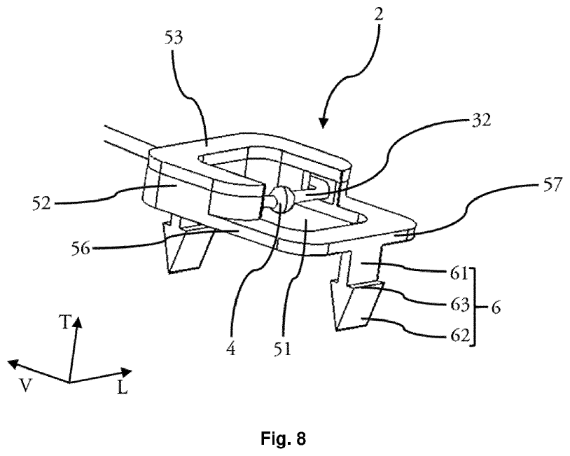

FIG. 8 illustrates a second embodiment of the temperature measurement device,

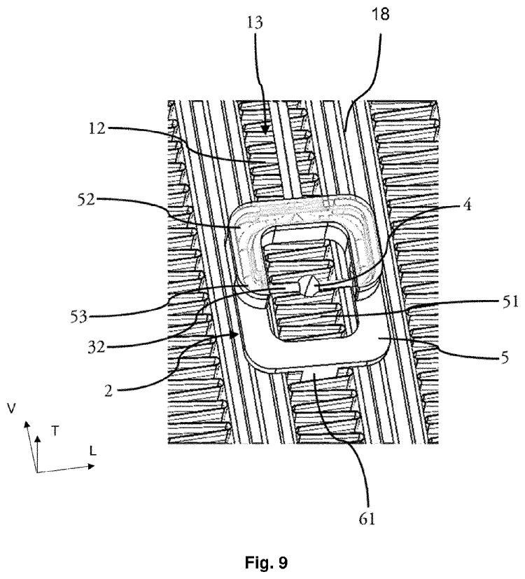

FIG. 9 shows the second embodiment of the temperature measurement device inserted into a radiating element of the radiator,

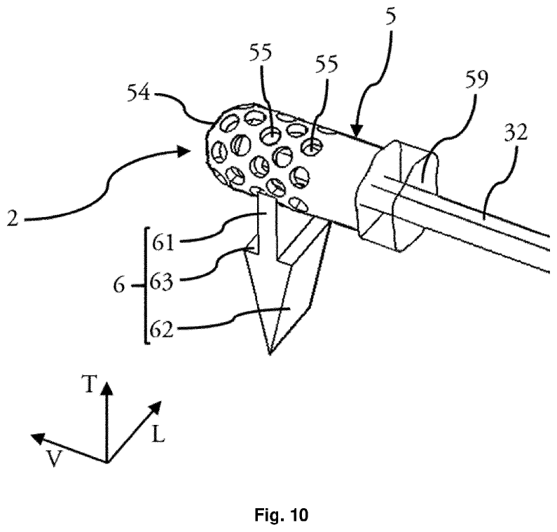

FIG. 10 shows a third embodiment of the temperature measurement device.

The trihedron LVT shows the orientation of the device according to the invention, in which the vertical direction V corresponds to an axis along which extends the main direction of the radiator, the transverse direction T corresponds to an axis parallel to the main direction of the air stream emanating from the radiator, and the longitudinal direction L corresponds to an axis perpendicular to the vertical direction V and the transverse direction T; this longitudinal direction L can also correspond to the main direction of elongation of the temperature measurement device. Such an orientation is arbitrary and independent of the orientation of the radiator in the vehicle.

FIG. 1 shows an electric radiator 1 on which a temperature measurement device 2 according to a first embodiment of the invention is positioned. The electric radiator 1 comprises a connection interface 11 and a rigid frame 16 on which this connection interface is fastened and configured to accommodate heating elements and radiating elements through which an air stream to be heated can pass.

The connection interface 11 includes means for connecting the radiator 1 to an electricity supply, not shown in FIG. 1. The connection interface 11 thus allows the current to flow in the electric radiator 1 in order to power the heating function thereof.

The frame 16 is directly linked to the connection interface 11 and includes a rigid structure having a rectangular shape for example. The frame 16 is configured to accommodate at least one heating element 18 and at least one radiating element 12. More particularly, here, the electric radiator 1 includes a plurality of heating elements 18 and a plurality of radiating elements 12 positioned alternately in a longitudinal direction, each element extending mainly in a vertical direction and having a thickness in a transverse direction.

Here, the heating element 18 is in the form of a tube extending over the entire vertical dimension along a vertical axis V of the frame 16. The heating elements 18 include PTC (positive temperature coefficient) stone or ceramic. The heating elements 18 thus form a heat source, when they are supplied with electricity, so as to heat an air stream 15 passing through the radiator 1 and leaving it through an output face 13 of the radiator 1.

Radiating elements 12 are positioned on either side of a heating element 18. The radiating elements 12 extend mainly along the vertical axis V in the same way as the heating element 18. The radiating elements 12 can for example take the form of a corrugated sheet forming a plurality of fins, the peaks of this corrugated sheet being rigidly connected to the two heating elements surrounding it or to a heating element and a rigid portion of the frame. The radiating elements 12 have the function of diffusing the heat generated by the heating element 18 and increasing the exchange surface area with the air stream 15 passing through the radiator to improve the transfer of heat energy.

The frame 16 has two perforated main faces to allow the air passing through the radiator to flow, each perforated face including vertical bars 17 that also contribute to holding the heating elements 18 and the radiating elements 12 inside the frame 16. The vertical bars 17 are positioned evenly on each of the perforated faces of the radiator and in particular, as can be seen in FIG. 1, on the output face 13 of the radiator 1.

The temperature measurement device 2 is placed on the output face 13 of the radiator 1. In the first embodiment of the temperature measurement device 2 illustrated in FIG. 1, the temperature measurement device 2 comprises a plurality of temperature sensors 4 installed on a support element 5, made in particular from a heat-resistant material.

The temperature measurement device 2 extends mainly in a direction parallel to the longitudinal direction L. The temperature sensors 4 are arranged on the support element 5 so that they are aligned along this longitudinal direction L. As can be seen in FIG. 1, the alignment of the temperature sensors 4 along the longitudinal direction, that is, the direction in which the heating elements and radiating elements are arranged against each other, makes it possible to measure the temperature of the air stream 15 leaving the radiator facing different radiating elements or heating elements. The plurality of temperature sensors 4 makes it possible for example to establish a mean temperature calculated from the data read by each of the temperature sensors 4.

The temperature sensors 4 are electrically connected by electrical wires that can be seen more particularly in FIG. 2 for example, and these cables extend to a sheath 3 that surrounds all of the electrical connection cables. The sheath 3 extends from the support element 5 to a connector 31, directly connected to the connection interface 11 of the radiator 1. In FIG. 1, the sheath 3 extends along the output face 13, in order to connect the temperature sensors 4 to the connection interface 11, without particular fastening means, but it can be envisaged to fasten this sheath, for example to one of the vertical bars 17 of the frame 16. The connector 31 is connected to the connection interface 11 of the radiator 1, for example to allow the supply of electricity to the temperature sensors 4 and to allow the transfer of the data measured by these sensors to the connection interface 11; the temperature measurements can be sent via the connection interface to a control module of the radiator configured to manage the power supply to said radiator as a function of the temperatures measured. For example, provision can be made for the control module to be configured with a temperature threshold value to be compared with the temperature values of the temperature sensors 4, and to reduce or increase the current supplying the heating elements 18 as a function of the comparison with the threshold value.

Here, the support element 5 is rectangular and includes means for fastening to radiating elements 12 as will be described below, so as to hold the temperature sensors 4 facing the output face 13 of the radiator 1.

FIG. 2 is an enlarged view of FIG. 1, more particularly showing the temperature measurement device 2 and the spherical heads of the temperature sensors 4. The temperature sensors are connected to electrical wires 32 that extend mainly longitudinally along an edge of the support element 5 and have a curved end portion so that the sensor heads at the end of these electrical wires are clear of the edges of the support element. The electrical wires 32 of each temperature sensor 4 are grouped together inside the sheath 3 that provides the link to the connection interface of the radiator 1.

FIG. 2 also shows details of the structure of the support element 5. In this embodiment, as stated above, the support element is rectangular. This rectangular shape is defined by vertical rails 56 and longitudinal rails 57. The vertical rails 56 extend along the vertical axis V, facing one of the heating elements 18 of the radiator or one of the vertical bars, so that they are not across the passage of the air stream passing through the radiator via the radiating elements 12. The longitudinal rails 57 extend along the longitudinal axis L, defining the main direction of extension of the support element 5. The length of the longitudinal rails 57 can vary, for example as a function of the number of temperature sensors 4 positioned on the support element 5.

The support element 5 also comprises intermediate rails 58 parallel to the vertical rails 56 and extending perpendicularly from one longitudinal rail 57 to another. The intermediate rails 58 contribute to defining a recess 51 for each of the temperature sensors 4 positioned on the support element 5, this recess 51 providing protection for the associated temperature sensor 4 and improving the reliability of the measurement taken by it. As can be seen in FIG. 2, a recess 51 can be formed between two intermediate rails 58 or between an intermediate rail 58 and a vertical rail 56 for the temperature sensors 4 situated at the ends of the support element 5.

FIG. 3 again shows the temperature measurement device 2 as shown in FIGS. 1 and 2, but this time alone, without the associated radiator. FIG. 3 shows the recesses 51 inside which the temperature sensors 4 are positioned and which are defined by the vertical rails 56, the longitudinal rails 57 and the intermediate rails 58. It can also be observed that the electrical wires 32 connected to the temperature sensors 4 come together at an end of the sheath 3 that is centered relative to the vertical rails 56. It will be understood that the length of each of the electrical wires 32 depends on the distance between each temperature sensor 4 and the sheath 3. These electrical wires 32 extending from the sensor heads are positioned in a channel 52 formed in the support element 5. More particularly, the channel 52 can be molded when the support element 5 is manufactured. The channel 52 contributes to the positioning and thermal protection of the electrical wires 32 inside the support element 5.

The support element 5 comprises at least one snap-fit fastening member 6, configured to hold the support element in position on the radiator. In this first embodiment of the temperature measurement device, the snap-fit fastening member extends mainly in a transverse direction T, from a wall of the support element 5 that is on the opposite side from the wall of the this support element comprising the channel 52.

The snap-fit fastening member 6 comprises a tab 61 extending along the transverse axis T and one or more ramps 62. The tab 61 can have a main lengthwise dimension adjusted as a function of the method of interaction with the radiating element selected for the snap-fit fastening member 6, as will be described in greater detail below.

The ramp(s) 62 protrude(s) from the tab 61, being positioned symmetrically on either side of the tab and evenly along the tab in the example shown. The snap-fit fastening member as shown in FIG. 3 is thus generally Christmas tree-shaped.

Each ramp 62 is in the shape of an inclined plane facilitating the insertion of the temperature measurement device 2 into the radiator as illustrated hereinafter. At least one ramp 62 is positioned at the free end of the tab 61, and the inclined plane that it forms extends in the direction of enlarging the vertical or longitudinal dimension, perpendicular to the transverse direction of the tab, moving away from the free end. The ramp 62 includes a stop wall 63 perpendicular to the transverse direction of the tab. The stop wall 63 is flat and forms a stopping surface that makes it possible to lock the temperature measurement device in position on the radiator.

FIG. 4 shows the snap-fit fastening member 6 as shown in FIG. 3 partially inserted into a radiating element 12 of a radiator. For reasons of clarity, only one radiating element 12 seen from the side and one fastening member 6 interacting with this radiating element are illustrated.

In FIG. 4, the radiating element 12 is seen from the side, that is, looking at it from a longitudinal viewing angle, so that this figure shows alternating peaks 120 that can be adhesively bonded or brazed to a first heating element, not shown here, and troughs 121 that can be adhesively bonded or brazed to a second heating element, not shown here. As stated previously, each radiating element consists of a corrugated sheet and therefore a succession of fins 122 formed between the peaks and the troughs. In the example illustrated, each fin of the radiating element 12 comprises a plurality of louvers 123 protruding from the walls of the radiating elements 12. The louvers 123 consist of local deformations of the fin, punched so as to form an opening through the fin, and they improve the diffusion of the heat crated by the radiator by increasing the exchange surface area with the air passing through the radiator, in particular by allowing the air to pass on either side of each fin via the openings that they form.

The temperature measurement device, and more particularly the snap-fit fastening member 6, is inserted into one of the radiating elements 12, substantially between two successive fins 122 of this radiating element, in an insertion direction 70 from the output face of the radiator. The inclined plane of the ramps 62 facilitates the insertion of the snap-fit fastening member 6 through the radiating element. The dimension of the ramps is determined so that the maximum vertical dimension of the fastening member is greater than the spacing between two facing louvers positioned respectively on a fin, so that when the fastening member is inserted into the radiating element, the ramps 62 deform at least one of the two facing louvers. FIG. 4 schematically illustrates the deformation of the louvers that were in the path of the snap-fit fastening member 6. A slight elastic return effect of the sheet forming the louvers tends to partially return the louvers in the path of the fastening member 6 once it has been inserted, so that the stop walls 63 act as a stop against disengagement by direct contact with the louvers 123. The plurality of ramps 62 increases the quantity of contact surface between the fastening member 6 and the deformed sheet of the radiating element 12, which tends to ensure the position of the fastening member 6 by friction. It will be understood that the device according to the invention makes it possible to ensure that the temperature sensor is held in place relative to the radiator, the effects of the stops and the friction being sufficient to contain the possible movements of the device due to the vibrations of the vehicle during driving. The temperature measurement device can then only be disengaged from the radiator by intentional pulling, causing the deformation of the louvers.

FIG. 5 shows a second embodiment of the fastening member 6 of the temperature measurement device 2. With the exception of the fastening member 6, all of the elements forming the temperature measurement device 2 are identical to those shown in FIG. 3, and reference can be made to the description thereof. In FIG. 5, the temperature measurement device includes two snap-fit fastening members but it will be understood that this number can vary without departing from the scope of the invention.

In this second embodiment, the snap-fit fastening member 6 is generally arrow-shaped, with two ramps 62 and two stop walls 63 positioned on either side of the tab 61, at the free end of the tab in the opposite direction to the support element 5. The main dimension of the tab 61 is intentionally larger than in the preceding embodiment, so that the snap-fit fastening member 6 can perform the function shown in the following figure.

FIG. 6 shows the snap-fit fastening member 6 as shown in FIG. 5 inserted into the radiator frame through one of the radiating element 12. For reasons of clarity, only the radiating element 12 and the associated fastening member 6 are illustrated. Here, the radiating element 12 is not provided with louvers, but includes as above a succession of fins formed between peaks and troughs respectively rigidly connected to a heating element. The second embodiment of the fastening member makes it possible to provide the fastening without the need for louvers formed on the fins. As for the first embodiment, the temperature measurement device, and more particularly the fastening member 6, is inserted into one of the radiating elements 12 in an insertion direction 70. The oblique shape of the ramps 62 formed at the end of the tab of the fastening member 6 facilitates the insertion thereof. As stated previously, the fastening member is configured so that the tab has a specific main dimension, namely a sufficient dimension to ensure that the fastening member 6 passes completely through the radiating element 12 along the transverse axis T. The ramps 62 and the stop walls 63 thus emerge on a face 14 on the opposite side from the output face 13 of the radiator through which the fastening member is inserted. The stop walls 63 of the fastening clip 6 act as a stop against disengagement in the opposite direction against an end of the radiating element 12 situated on the face 14. The interaction between the stop walls 63 of the fastening clip 6 and the end of the radiating element 12 makes it possible to prevent the disengagement of the temperature measurement device from the radiator. FIG. 7 shows the face 14 of the radiator, from which the ramps 62 and the stop faces 63 of the fastening member according to the second embodiment emerge.

It will be understood that FIGS. 6 and 7 are schematic representations that aim to illustrate in particular the specific feature according to which the main dimension of the tab of the fastening member is sufficiently large so that the fastening member passes completely through the heating element and the ramp goes beyond said radiating element. It should be understood that the fins present in the path of the fastening member when it is inserted are deformed due to the spacing of each fin relative to its neighboring fin, which is smaller than the corresponding maximum dimension, vertical here, of the ramp. As above, a slight elastic return effect of the fins contributes to holding the snap-fit fastening member in position.

FIG. 8 shows a second embodiment of the temperature measurement device 2 and FIG. 9 also shows the second embodiment of the temperature measurement device 2 inserted between the fins of a radiating element 12 of a radiator.

The second embodiment of the temperature measurement device 2 comprises a support element 5 that is a different shape from the one described above. Here, the body of the support element 5 is defined by a pair of vertical rails 56 and a pair of longitudinal rails 57 arranged in the shape of a quadrilateral and defining between them an orifice forming a recess 51 that can receive the temperature sensor 4. The measurement device according to the second embodiment comprises two snap-fit fastening members 6 each comprising, in a similar manner to that described above, a tab 61, ramps 62 and stop walls 63. The fastening members 6 shown in FIGS. 8 and 9 are arrow-shaped but any embodiment of the fastening members 6 disclosed above can be fitted to this second embodiment of the temperature measurement device 2.

Unlike in the above, here, the fastening members are aligned in the vertical direction, that is, in the direction of elongation of the radiating elements 12 and heating elements 18. They originate respectively from one of the longitudinal rails 57, in the opposite direction relative to the recess 51.

The head of the temperature sensor 4 is positioned in the center of the recess 51, so that it is clear of the rails in order to ensure that the temperature of the air stream leaving the radiator is correctly captured, and to this end it is positioned between two branches of electrical wires 32 that run respectively along opposite vertical rails, in a specific channel 52. More particularly, the channel 52 is formed on each vertical rail 56 by upright walls between which the channel extends. This results in a specific shape of the support element with one half raised relative to the other half and in which the channels are formed between the walls.

As can be seen in FIG. 9, the support element is sized so that the distance between the vertical rails 56 is substantially equal to the distance between two neighboring heating elements of the radiator. As a result, when the snap-fit fastening members are inserted into one of the radiating elements 12, the vertical rails 56 of the support element are positioned facing the heating elements 18, without impairing the flow of air through the radiating elements of the radiator.

The channel 52 of this second embodiment can be more clearly described with reference to FIG. 9. The channel 52 can for example be obtained during the molding of the support element 5, by means of a slide positioned between the rails forming the raised part of the support element. The channel 52 thus follows the shapes of the support element 5, skirting the recess 51. The electrical wires 32 are inserted into the channel 52 and extend to the temperature sensor 4 suspended in the center of the recess 51 and held by two electrical wires 32, each skirting the recess 51 on either side of the temperature sensor 4.

The electrical wires run along an outer face of the support element, that is, a face pointing in the opposite direction to the radiator. The temperature sensor 4 is thus held at a distance of at least 10 mm from the radiator, in particular dependent on the thickness of the support element, here its dimension in the transverse direction. The channel 52 can be closed by a cover 53 that covers the free end of the walls defining the channel 52, and thus contributing, like the channel, to the mechanical holding and thermal protection of the electrical wires 32.

As illustrated in FIG. 9, the electric wires 32 extend from the temperature sensor 4 until they meet and continue outside the support element 5, to the connection interface of the radiator.

FIG. 10 shows a third embodiment of the temperature measurement device 2. The temperature measurement device 2 comprises a temperature sensor that is not shown in FIG. 10 as it is accommodated in the support element 5. Unlike the preceding two embodiments, the temperature sensor is fully enclosed in the support element 5, which is in the shape of a cap 54. Only one end 59 of the cap 54 is open so as to allow the sensor head to be inserted into the cap and the electrical wires 32 powering the temperature sensor to enter. So that the temperature sensor can perform its temperature measurement function and therefore be in contact with the air passing through the radiator, the cap 54 is pierced with a plurality of orifices 55. The orifices 55 can for example be circular, but any shape can be envisaged, the main point being that the air stream leaving the radiator has access to the temperature sensor.

The cap 54 comprises, as in the preceding embodiments, a fastening member 6, again provided with the tab 61, the ramps 62 and the stop walls 63. The fastening member 6 shown in FIG. 10 is arrow-shaped but any embodiment of the fastening members 6 disclosed above can be fitted to this embodiment of the temperature measurement device 2.

The invention is not limited to the means and configurations described and illustrated herein, however, and also extends to all equivalent means or configurations and to any technically operational combination of such means. In particular, the shapes of the support element and/or the fastening member can be modified without detriment to the invention, provided that they fulfill the functions described in this document.

The embodiments described above are thus in no way limiting, and it will be possible, in particular, to envisage variants of the invention that comprise only a selection of the features described below, in isolation from the other features described in this document, if this selection of features is sufficient to confer a technical advantage or to distinguish the invention from the prior art.

1. An electric radiator for a motor vehicle comprising:
a rigid frame accommodating heating elements and radiating elements through which an air stream can pass;
a temperature measurement device including at least one temperature sensor; and
a support element comprising at least one recess for one or more temperature sensors and a device for fastening to the electric radiator,
wherein the fastening device associated with the support element includes at least one snap-fit fastening member configured to interact with one of the radiating elements of the radiator.

2. The electric radiator as claimed in claim 1, in which each snap-fit fastening member is configured to allow the removable fastening of the temperature measurement device to one of the radiating elements.

3. The electric radiator as claimed in claim 1, in which each snap-fit fastening member comprises a tab extending from a body of the support element and one or more ramps protruding from said tab.

4. The electric radiator as claimed in claim 1, in which each snap-fit fastening member is sized to deform the corresponding radiating element when the temperature sensor is assembled on the radiator in a first translation direction and the corresponding radiating elements are formed between two rigid elements so as to generate an elastic return effect that tends to prevent the disengagement of the fastening member in a second translation direction opposite to the first direction.

5. The electric radiator as claimed in claim 1, in which the support element has an elongated shape in a longitudinal direction along which several recesses are positioned in series, and in which the snap-fit fastening members are aligned in the same longitudinal direction so that each snap-fit fastening member interacts with a radiating element specific thereto.

6. The electric radiator as claimed in claim 1, in which the support element is associated with a single temperature sensor and has a compact shape defining a single recess, and in which the snap-fit fastening members are facing on either side of the recess so that the snap-fit fastening members interact with the same radiating element.

7. The electric radiator as claimed in claim 1, in which each temperature sensor is configured to be connected to a connection interface of the radiator by one or more electrical wires, the support element including at least one channel accommodating the electrical wires.

8. The electric radiator as claimed in claim 1, in which the support element is in the shape of a cap the inside of which defines said recess, the cap enclosing a single temperature sensor and being pierced with orifices capable of letting the air through to the temperature sensor.

9. The electric radiator as claimed in claim 3, in which the snap-fit fastening member is inserted between fins of one of the radiating elements of the radiator through an air output face thereof, the tab of the fastening clip having a main dimension with a value larger than the value of a corresponding dimension of the radiating elements of the radiator and extending so that a stop wall of the ramp stops on an air input face of the radiator.

10. The radiator as claimed in claim 1, in which the temperature sensor is situated at a distance of at least 10 mm from an air output face of the radiator.

11. An electric radiator for a motor vehicle comprising:
a frame accommodating heating elements and radiating elements through which an air stream is configured to pass;
a temperature measurement device including at least one temperature sensor; and
a support element comprising at least one recess for the at least one temperature sensor and a fastening device for fastening the temperature sensor to the radiating elements of the electric radiator,
wherein the fastening device associated with the support element includes at least one hooking means sized so as to be accommodated between fins of one of the radiating elements.
